(19) United States
(12) Patent Application Publication
(10) Pub. No.: US 2004/0009456 A1
(43) Pub. Date: Jan. 15, 2004

(54) Method of assisting in the provision of medical care

(76) Inventor: Christina Ruth Mann, Toronto (CA)

Correspondence Address: CHRISTINA RUTH MANN, Suite 701, 284 Bloor Street West, Toronto, ON, M5S 3B8, CA

(21) Appl. No.: 10/134,403

(22) Filed: Jul. 11, 2002

(51) Int. Cl. G09B 19/00

(52) U.S. Cl. 434/236

(57) ABSTRACT

A method of assisting in the provision of medical care is disclosed. The method comprises the steps of alternating leg movements and arm movements while laying on one's back, in order to amuse and entertain a distressed visotor, thereby providing emotional support the the visitor. The emotional support may also be thus provided indirectly to a person undergoing surgery.

### FIELD OF THE INVENTION

The present invention pertains generally to the provision of emotoinal support to a distressed visitor of a person undergoing surgery.

### BACKGROUND OF THE INVENTION

With increses in the costs of providing medical care, health care, etc., along with the growing costs of health care, there is an increase in the need to reduce stress, especially in the case of a visitor who might normally wear a heart monitor or biofeedback computer that is not functioning properly.

Younger patients can often assist in the stress reduction process, especially when surgery can often increase the stress involved.

The method is particularly applicable to comforting a distressed father.

In particular, the method may be practiced when released from the womb of a mother by way of an incision in the belly of the mother, to comfort the father while the father is in a state of panic at the sight of his wife having been cut open.

The distraction, with such cute gestures and movements, allows medical staff sufficient time to repair the damage to the mother.

Particularly complex cute behaviour helps keep the father amused, especially if the phase of movement between legs and feet, or between legs and arms is sufficiently random, shifted, or especially if the frequency or periodicity is sufficiently different.

A novel mixture of different periodicities and phase shifts can be used to synthesize a simulation of in-phase and quadrature ambulation that will entertain the father.

Alternatively, moving all four limbs in a pattern having high fractal dimension while aiming the head back and forth in the direction of the father, provides further amusement.

These patterns may cause sufficient amusement to be picked up and carried by the father to being within view of the mother, and thus also provide amusement and comfort to the mother.

### SUMMARY OF THE INVENTION

The invention consists of a method of providing emotional support to a visitor in a health care setting.

In one aspect of the invention, a user of the invention moves her arms and legs alternately while laying on her back, in order to amuse a distressed visitor.

In another aspect of the invention, she tilts her head toward the distressed visitor, and then moves her feet in an oscilatory periodic motion commensurate with the movement of her legs.

In another aspect of the invention, she moves her feet in an oscilatory periodic motion together with the movement of her legs, in which the frequency of periodic motion of her legs and that of her feet are not an integer multiple of one another.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 is a timing diagram showing arm and leg movement.

FIG. 2 is a diagram of a facial expression modulator.

### DETAILED DESCRIPTION OF THE PREFERRED EMBODIMENTS

While the invention shall now be described with reference to the preferred embodiments shown in the drawing, it should be understood that the intention is not to limit the invention only to the particular embodiments shown but rather to cover all alterations, modifications and equivalent arrangements possible within the scope of appended claims.

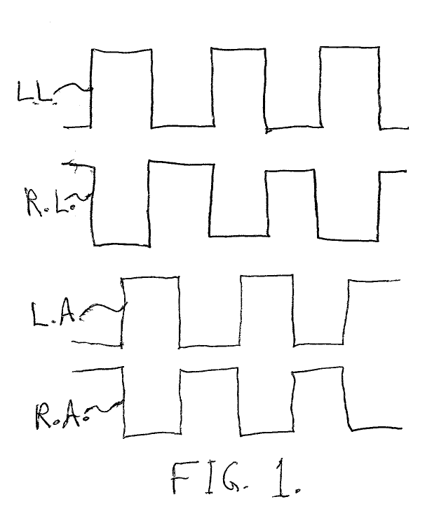

FIG. 1 depicts arm and leg movement, in which left leg LL and right leg RL operate out of phase by an angle π (e.g. alternately), with respect to one another. Left arm LA and right arm RA also operate alternately (phase angle π between them). A phase shift of π/2 between arms and legs, provides an amusing feature. Alternatively, other asynchronous movements between arms and legs may also provide such amusement through the novelty of this movement.

By moving the arms and legs at different frequencies, but with the phase shift of π between left arm and right arm, together with the phase shift of π between left leg and right leg, other cute amusing effects can be achieved.

A facial expression that is modulated in a quasi periodic or cyclostationary manner, may also be used to modulate the phase or frequency of arm or leg movements, further amusing the father, while the mother is being stitched back together.

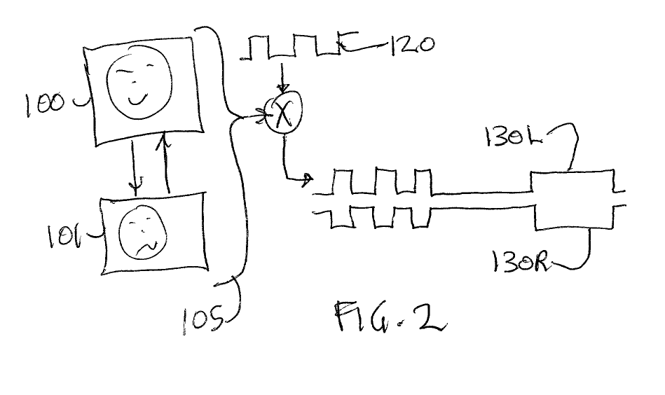

Additionally, the arms and legs may be moved in a more random manner, of high fractal dimension, while a period or near-periodic facial expression is used to modulate at least on aspect of said more random manner. FIG. 2 depicts a facial expression modulator. A first facial expression 100 is

generated first. Subsequently a second facial expression 101 is then generated. Additionally, the method involves transitioning between the two facial expressions in a period pattern 105. The periodic pattern 105 modulates a periodic arm or leg movement, 130L of the left side of the body and 130R of the right side of the body, 130L being out of phase with 130R by an angle of π.

The modulation is performed by construction of a time base 120 to be modulated by a modulator 110. The modulator can be thought of internally, or can be performed by periodic gestures on time base 120 and performing other period gestures as modulated from this first period gesture on time base 120, to get modulated gestures 130L and 130R.

From the foregoing description, it will thus be evident that the present invention provides a design for a method of assisting in the providing medical care. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

The embodiments of the invention in which I claim an exclusive property or privilege are defined as follows: What I claim as my invention is:

1. A method of providing amusement to a vistor of a patient, said method comprising the steps of:
alternate approximately periodic gesture by way of a first pair of body parts about an approximate central axis of symmetry;
alternate approximately periodic gesture by way of a second pair of body parts about an approximate central axis of symmetry; said gesture by way of said first pair of body parts being out of phase with that of said second pair of body parts.

2. The method of claim 1 where said first pair of body parts are legs.

3. The method of claim 2 where said second pair of body parts are arms.

4. The method of claim 2 where said second pair of body parts are feet.

5. The method of claim 1 where said visitor is a husband of said patient.

6. The method of claim 1 where a person providing said amusement is a newborn baby of said patient.

7. A method of providing amusement to a distressed husband of a patient, said method comprising the steps of:
being released from a womb of said patient by way of an incision in the belly of said patient;
distracting said husband by way of performing alternate approximately periodic movement of a first pair of body parts about an approximate central axis of symmetry, alternate approximately periodic movement of a second pair of body parts about an approximate central axis of symmetry, said movement of said first pair of body parts being out of phase with said second pair of body parts,
said distracting performed while said incision is being repaired.

8. A method of providing amusement to a distressed visitor of a patient said method for being practiced by a person recently released from a womb of said patient by way of an incision in the belly of said patient, said method comprising the steps of:
moving of legs in an alternate approximately periodic pattern about an approximate central axis of symmetry;
movement of at least one of:
feet;
arms,
about an approximate central axis of symmetry, said movement being out of phase with said movement of said legs.
